(19) United States
(12) Patent Application Publication
(10) Pub. No.: US 2023/0078335 A1
(43) Pub. Date: Mar. 16, 2023

(54) CLEANING LIQUID AND INKJET RECORDING APPARATUS LIQUID SET

(71) Applicant: KYOCERA Document Solutions Inc., Osaka (JP)

(72) Inventor: Yasuko TAKAORI, Osaka-shi (JP)

(73) Assignee: KYOCERA Document Solutions Inc., Osaka (JP)

(21) Appl. No.: 17/822,620

(22) Filed: Aug. 26, 2022

(30) Foreign Application Priority Data
Aug. 27, 2021 (JP) 2021-138862

(51) Int. Cl. C09D 9/04; C09D 11/40; C09D 11/322; C09D 11/38; C09D 11/037; C09D 11/033; C09D 11/107; C09D 11/108; C09D 11/102

(52) U.S. Cl. CPC C09D 9/04; C09D 11/40; C09D 11/322; C09D 11/38; C09D 11/037; C09D 11/033; C09D 11/107; C09D 11/108; C09D 11/102

(57) ABSTRACT

A cleaning liquid contains water, a surfactant, and glycol ether. The surfactant includes both a silicone surfactant and a betaine surfactant. The glycol ether has a percentage content of at least 5.0% by mass and no greater than 15.0% by mass relative to the mass of the cleaning liquid. The cleaning liquid has a viscosity at 25° C. of 10.0 mPa·s.

### INCORPORATION BY REFERENCE

The present application claims priority under 35 U.S.C. § 119 to Japanese Patent Application No. 2021-138862, filed on Aug. 27, 2021. The contents of this application are incorporated herein by reference in their entirety.

### BACKGROUND

The present disclosure relates to a cleaning liquid and a inkjet recording apparatus liquid set.

Image printing was performed on a recording medium by ejecting ink from a recording head of an inkjet recording apparatus. Various cleaning liquids are studied for ink cleaning. For example, a method is known for washing a hard surface forming an ink production line. In the washing method, a detergent is used that contains an alkaline agent, alkylamine oxide, and an organic solvent with a solubility parameter at 20° C. of at least 8 and no greater than 12.

### SUMMARY

A cleaning liquid according to an aspect of the present disclosure contains water, a surfactant, and glycol ether. The surfactant includes both a silicone surfactant and a betaine surfactant. The glycol ether has a percentage content of at least 5.0% by mass and no greater than 15.0% by mass relative to a mass of the cleaning liquid. The cleaning liquid has a viscosity at 25° C. of no greater than 10.0 mPa·s.

A inkjet recording apparatus liquid set according to an aspect of the present disclosure includes a first liquid and a second liquid. The first liquid is an ink and the second liquid is a cleaning liquid. The ink contains pigment particles and water. The cleaning liquid contains water, a surfactant, and glycol ether. The surfactant includes both a silicone surfactant and a betaine surfactant. The glycol ether has a percentage content of at least 5.0% by mass and no greater than 15.0% by mass relative to a mass of the cleaning liquid. The cleaning liquid has a viscosity at 25° C. of no greater than 10.0 mPa·s.

### DETAILED DESCRIPTION

The following describes embodiments of the present disclosure. The terms used in the present specification are explained first. Unless otherwise stated, measurement values for volume median diameter (D50) are median diameters in terms of volume as measured using a laser diffraction particle size distribution analyzer (product of SYSMEX CORPORATION, “ZETASIZER NANO ZS”). Measurement values for acid value are values as measured in accordance with “Japanese Industrial Standard (JIS) K 0070-1992” unless otherwise stated. Measurement values for mass average molecular weight (Mw) are values as measured using gel permeation chromatography unless otherwise specified. HLB values are values as calculated based on the Griffin method using a formula “HLB value=20×(sum of formula weights of hydrophilic parts)/molecular weight” unless otherwise stated. Dynamic surface tensions are values as measured at 1 Hz using a bubble pressure-type dynamic surface tensiometer (“KRUSS BP-100”, product of KRUSS) unless otherwise stated. The term “(meth)acryl” may be used as a generic term for both acryl and methacryl. The phrase “independently of one another” in description about formulas means possibly representing the same group or different groups. Any of components described in the present specification may be used independently or in combination. The terms used in the present specification have been explained so far.

### First Embodiment: Cleaning Liquid

The following describes a cleaning liquid according to a first embodiment of the present disclosure. The cleaning liquid according to the first embodiment is a cleaning liquid for inkjet recording apparatus use, and is a water-based cleaning liquid containing water. The cleaning liquid according to the first embodiment contains water, a surfactant, and glycol ether. The cleaning liquid may further contain a water-soluble organic solvent as necessary. In the following, a “surfactant contained in the cleaning liquid” and an “aqueous organic solvent contained in the cleaning liquid” may be referred to as “surfactant C” and “water-soluble organic solvent C”, respectively.

In the cleaning liquid according to the first embodiment, the surfactant C includes both a silicone surfactant and a betaine surfactant. The glycol ether has a percentage content of at least 5.0% by mass and no greater than 15.0% by mass relative to the mass of the cleaning liquid. The cleaning liquid has a viscosity at 25° C. of no greater than 10.0 mPa·s.

A recording head of an inkjet recording apparatus has an ejection surface in which nozzle orifices are formed. An ink is ejected from the nozzle orifices toward a recording medium. The ejection surface is typically subjected to a water-repellent finish. However, because the nozzle orifices are openings in a plate subjected to water-repellent finish, there are areas on the inner surfaces of the nozzle orifices and on proximate area surfaces to the nozzle orifices on the ejection surface where the water-repellent finish is insufficient. In the following, “the inner surfaces of the nozzle orifices and the proximate area surfaces to the nozzle orifices on the ejection surface” may be also referred to as “the nozzle inner surfaces and the proximate area surfaces”. When ink is not ejected for an extended period, the ink may dry and stick to the nozzle inner surfaces and the proximate area surfaces. In the following, the “dried and stuck ink” may be referred to as “stuck ink”. Stuck ink can cause nozzle clogging and a decrease in accuracy of ink placement, for example.

Stuck ink tends to occur particularly in a case using an ink that dries quickly and that adheres to a low-absorbency recording medium with low absorbency to water and a non-absorbency recording medium that does not absorb water. In the following “the non-absorbency recording medium and the low-absorbency recording medium” may be referred collectively to “specific recording medium”. This is because such an ink contains a large amount (e.g., an amount of at least 0.9% by mass and no greater than 3.0% by mass relative to the mass of the ink) of a binder resin (e.g., a second resin described later in a second embodiment) for binding the ink to the specific recording medium in addition to a pigment dispersion resin (e.g., a first resin described later in the second embodiment) for dispersing pigment particles.

Here, the cleaning liquid according to the first embodiment contains a silicone surfactant. The cleaning liquid according to the first embodiment further contains glycol ether at a percentage content of no greater than 15.0% by mass relative to the mass of the cleaning liquid. The cleaning liquid has a viscosity at 25° C. of no greater than 10.0 mPa·s. With the above features, the contact angle of the cleaning liquid relative to the nozzle inner surfaces and the proximate area surfaces (e.g., the nozzle inner surfaces and the proximate area surfaces made from austenitic stainless steel) is reduced to a desired value to make the nozzle inner surfaces and the proximate area surfaces get wet easily. As a result, the cleaning liquid favorably penetrates into gaps between the stuck ink and the nozzle inner surfaces or the proximate area surfaces.

Furthermore, the cleaning liquid according to the first embodiment contains glycol ether at a percentage content of at least 5.0% by mass relative to the mass of the cleaning liquid. Glycol ether tends to function as a plasticizer for a pigment dispersion resin and a binder resin contained in an ink. As such, after the cleaning liquid penetrates into the gaps between the stuck ink and the nozzle inner surfaces or the proximate area surfaces, the glycol ether contained in the cleaning liquid renders the pigment dispersion resin and the binder resin contained in the stuck ink plastic. As a result, the stuck ink swells and is readily removed from the nozzle inner surfaces and the proximate area surfaces. Accordingly, an ink even with excellent adhesion to the specific recording medium can be favorably cleaned with the cleaning liquid according to the first embodiment.

As described previously, the cleaning liquid according to the first embodiment easily penetrates into the gaps between the stuck ink and the nozzle inner surfaces or the proximate area surfaces. Therefore, a portion of the stuck ink (specifically, a portion of the stuck ink present in the vicinity of the interface between the stuck ink and each nozzle inner surface or each proximate area surface) selectively swells and is dissolved when the cleaning liquid according to the first embodiment is used. As such, the stuck ink is easily removed from the nozzle inner surfaces and the proximate area surfaces before all the stuck ink is dissolved. Since it is sufficient if a portion, rather than all, of the stuck ink is dissolved, a time necessary for dissolving the stuck ink is shortened, with a result that the nozzle inner surfaces and the proximate area surfaces can be cleaned in a shortened time period.

Furthermore, the cleaning liquid according to the first embodiment contains a betaine surfactant in addition to a silicone surfactant. The ejection surface of the recording head includes a water-repellent film formed through repellent finishing. When the ejection surface is wiped using for example a wiping blade after the cleaning liquid is supplied to the ejection surface, the betaine surfactant reduces frictional resistance between the wiping blade and the water-repellent film of the ejection surface. As a result, the water-repellent film is hardly shaven off and the stuck ink is easily removed from the nozzle surface of the recording head. Therefore, even when an ink excellent in adhesion to the specific recording medium is used, the ink is favorably cleaned with the cleaning liquid according to the first embodiment.

Note that the cleaning liquid according to the first embodiment can exhibit excellent cleaning ability even when an ink suitable for a recording medium (e.g., plain paper) other than the specific recording medium is used. Therefore, the cleaning liquid according to the present disclosure can be favorably used even in printing on a recording medium other than the specific recording medium.

The cleaning liquid according to the first embodiment is a one-liquid cleaning liquid for cleaning use including one cleaning liquid, for example. Furthermore, the cleaning liquid and a later-described ink may be contained in different containers, for example.

(Contact Angle of Cleaning Liquid)

The cleaning liquid preferably has a contact angle relative to an austenitic stainless steel plate of no greater than 25 degrees. In the present specification, the “austenitic stainless steel” means “SUS304” defined in the Japanese Industrial Standards (JIS) G 4305:2012 “Cold-rolled stainless steel plate, sheet and strip”. In the following, the “austenitic stainless steel” may be also referred to below as “SUS304”. In a case in which the material of the ejection surface of the recording head of the inkjet recording apparatus is SUS304, for example, the contact angle of the cleaning liquid relative to the SUS304 plate corresponds to a contact angle of the cleaning liquid relative to the ejection surface (particularly, the nozzle inner surfaces and the proximate area surfaces).

As a result of the contact angle of the cleaning liquid being set to no greater than 25 degrees relative to a SUS304 plate, the cleaning liquid quickly penetrates into the gaps between the stuck ink and the nozzle inner surfaces or the proximate area surfaces to favorably clean the stuck ink. No particular limitations are placed on the lower limit of the contact angle of the cleaning liquid relative to the SUS304 plate, and the lower limit thereof is at least 10 degrees, for example.

The contact angle of the cleaning liquid relative to the SUS304 plate can be adjusted for example by changing the type of the surfactant C and the percentage content of the glycol ether. As a result of the surfactant C including both a silicone surfactant and a betaine surfactant, the contact angle of the cleaning liquid relative to the SUS304 plate can be easily adjusted to no greater than 25 degrees. Furthermore, as a result of the percentage content of the glycol ether being set to no greater than 15.0% by mass relative to the mass of the cleaning liquid, the contact angle of the cleaning liquid can be easily adjusted to no greater than 25 degrees relative to the SUS304 plate. A method of measuring a contact angle of the cleaning liquid relative to the SUS304 plate will be described later in Examples.

(Viscosity of Cleaning Liquid)

The cleaning liquid has a viscosity at 25° C. of no greater than 10.0 mPa·s. In the following, the viscosity of a cleaning liquid at 25° C. may be referred to as “cleaning liquid viscosity”. As described previously, as a result of the cleaning liquid viscosity being set to no greater than 10.0 mPa·s, the contact angle of the cleaning liquid relative to the nozzle inner surfaces and the proximate area surfaces reduces to a desired value to make the nozzle inner surfaces and the proximate area surfaces readily get wet. Furthermore, as a result of the cleaning liquid viscosity being set to no greater than 10.0 mPa·s, the cleaning liquid hardly remains in cleaning the ejection surface using the cleaning liquid. Preferably, the cleaning liquid viscosity is no greater than 5.0 mPa·s. No particular limitations are placed on the lower limit of the cleaning liquid viscosity, and the lower limit thereof is at least 1.0 mPa·s, for example. The cleaning liquid viscosity can be adjusted by changing the percentage content of the glycol ether or the percentage content of the water-soluble organic solvent C. The lower the percentage content of the glycol ether is, the lower the cleaning liquid viscosity is. A method for measuring the cleaning liquid viscosity will be described later in Examples.

(Surfactant C)

As a result of the cleaning liquid containing the surfactant C, the contact angle of the cleaning liquid relative to the SUS304 plate reduces to a desired value to make the SUS304 plate readily get wet with the cleaning liquid, for example. The surfactant C functions as a wetting agent for increasing wettability to the SUS304 plate. The surfactant C includes both a silicone surfactant and a betaine surfactant.

In the present specification, the betaine surfactant means a surfactant with betaine structure. The betaine structure is represented by formula (1). In the formula (1), * represents a bond, more specifically represents a bond for bonding to an atom constituting the betaine surfactant.

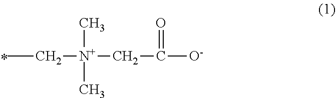

Examples of the betaine surfactant include an amide betaine surfactant and an aminoacetic acid betaine surfactant.

The amide betaine surfactant will be described first. Example of the amide betaine surfactant include a fatty acid amide alkyl betaine surfactant. The fatty acid amide alkyl betaine surfactant is preferably a compound represented by formula (2A).

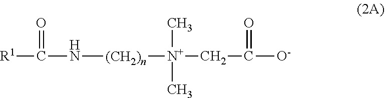

In formula (2A), R¹ represents a chain monovalent hydrocarbon group with a carbon number of at least 6 and no greater than 20 and n represents an integer of at least 1 and no greater than 5. R¹ preferably represents a chain monovalent hydrocarbon group with a carbon number of at least 10 and no greater than 18. Examples of the chain monovalent hydrocarbon group represented by R¹ include an alkyl group and an alkenyl group. Preferably, n represents 3. Note that where n represents 3, the compound represented by formula (2A) is a later-described fatty acid amide propyl betaine surfactant.

An example of the fatty acid amide alkyl betaine surfactant is a fatty acid amide propyl betaine surfactant. Examples of the fatty acid amide propyl betaine surfactant include coconut oil fatty acid amide propyl betaine, lauric acid amide propyl betaine, palm kernel amide propyl betaine, amide propyl betaine isostearate, and amide propyl linoleate.

The aminoacetic acid betaine surfactant will be described next. The aminoacetic acid betaine surfactant is preferably a compound represented by formula (2B).

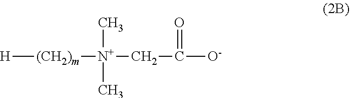

In formula (2B), m represents an integer of at least 5 and no greater than 30. m preferably represents an integer of at least 10 and no greater than 25, more preferably represents an integer of at least 10 and no greater than 15, and further preferably represent 12. Note that where m represents 12, the compound represented by formula (2B) is later-described lauryl dimethylamino acetate betaine described later.

Example of the amino acetate betaine surfactant includes alkyldimethylamino acetate betaine surfactants. Examples of the alkyldimethylamino acetate betaine surfactants include lauryl dimethylamino acetate betaine, palmityldimethylamino acetate betaine, stearyl dimethylamino acetate betaine, and behenyl dimethylamino acetate betaine.

The betaine surfactant is preferably a fatty acid amide alkyl betaine surfactant or an amino acetate betaine surfactant, more preferably a fatty acid amide propyl betaine surfactant or an alkyldimethylamino acetate betaine surfactant, and further preferably coconut oil fatty acid amide propyl betaine or lauryl dimethylamino acetate betaine.

The betaine surfactant is an amphoteric surfactant, for example. The percentage content of the betaine surfactant is preferably no greater than 0.5% by mass relative to the mass of the cleaning liquid, and more preferably no greater than 0.4% by mass. The percentage content of the betaine surfactant is preferably at least 0.1% by mass relative to the mass of the cleaning liquid, and more preferably at least 0.2% by mass. As a result of the percentage content of the betaine surfactant being set to at least 0.1% by mass and no greater than 0.5% by mass relative to the mass of the cleaning liquid, the contact angle of the cleaning liquid is easily adjusted within a desired value range. Furthermore, as a result of the percentage content of the betaine surfactant being set to no greater than 0.5% by mass relative to the mass of the cleaning liquid, the cleaning liquid hardly foams up.

In the present specification, the silicone surfactant means a surfactant having a siloxane bond. The silicone surfactant is preferably a polyether-modified silicone, and more preferably a polyether-modified polydimethylsiloxane or polyether-modified organosiloxane. The polyether-modified polydimethylsiloxane preferably includes a repeating unit represented by formula (3), and more preferably includes the repeating unit represented by formula (3) and an end group represented by formula (4).

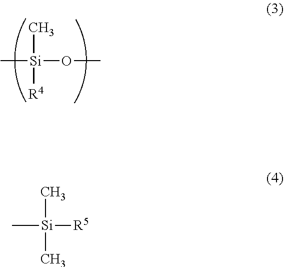

R⁴ in formula (3) and R⁵ in formula (4) each represent, independently of one another, a methyl group or a polyether group. However, at least one of R⁴ and R⁵ represents a polyether group. The polyether group is a group including either or both —C₂H₄O— and —C₃H₆O—.

The silicone surfactant is a nonionic surfactant, for example. The silicone surfactant has an HLB value of preferably at least 3 and no greater than 20, more preferably at least 6 and no greater than 16, further preferably at least 8 and no greater than 14, and particularly preferably at least 9 and no greater than 14. Alternatively, the silicone surfactant may have an HLB value of at least 8 and no greater than 10, greater than 10 and no greater than 12, or greater than 12 and no greater than 14.

The dynamic surface tension of an aqueous solution of 0.1% by mass of the silicone surfactant is preferably at least 20 mN/m and no greater than 50 mN/m, and more preferably at least 25 mN/m and no greater than 40 mN/m.

The percentage content of the silicone surfactant is preferably no greater than 1.5% by mass relative to the mass of the cleaning liquid, and more preferably no greater than 1.3% by mass. The percentage content of the silicone surfactant is preferably at least 0.5% by mass relative to the mass of the cleaning liquid, and more preferably at least 0.7% by mass. As a result of the percentage content of the silicone surfactant being set to at least 0.5% by mass and no greater than 1.5% by mass relative to the mass of the cleaning liquid, the contact angle of the cleaning liquid is easily adjusted within a desired value range. Furthermore, as a result of the percentage content of the silicone surfactant being set to no greater than 1.5% by mass relative to the mass of the cleaning liquid, a component contained in the cleaning liquid hardly agglomerates.

The ratio of the mass of the betaine surfactant to the mass of the silicone surfactant is preferably at least 0.1 and no greater than 0.9, more preferably at least 0.2 and no greater than 0.5, and particularly preferably 0.3.

The cleaning liquid may further contain a surfactant C other than the silicone surfactant and the betaine surfactant. Examples of the surfactant C other than the silicone surfactant and the betaine surfactant are the same as those listed as examples of a surfactant I described later in the second embodiment.

(Glycol Ether)

Glycol ether has compatibility with a cleaning liquid containing water and can swell a pigment dispersion resin and a binder resin contained in an ink.

Examples of the glycol ether contained in the cleaning liquid include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, propylene glycol monomethyl ether, and dipropylene glycol monomethyl ether.

The glycol ether contained in the cleaning liquid is preferably alkylene glycol alkyl ether, more preferably alkylene glycol alkyl ether with a carbon number of at least 3 and no greater than 11, further preferably alkylene glycol alkyl ether with a carbon number of at least 5 and no greater than 10, and furthermore preferably triethylene glycol monobutyl ether, diethylene glycol monoethyl ether, or dipropylene glycol monomethyl ether.

As described previously, the percentage content of the glycol ether is at least 5.0% by mass and no greater than 15.0% by mass relative to the mass of the cleaning liquid. As a result of the percentage content of the glycol ether being set to no greater than 15.0% by mass relative to the mass of the cleaning liquid, the glycol ether hardly inhibits movement of the surfactant C to the air-liquid interface between the air and the cleaning liquid. Once the surfactant C moves to the air-liquid interface, the contact angle of the cleaning liquid relative to the nozzle inner surfaces and the proximate area surfaces easily reduces to a desired value. As a result of the percentage content of the glycol ether being set to at least 5.0% by mass relative to the mass of the cleaning liquid, the pigment dispersion resin and the binder resin contained in the stuck ink are rendered plastic, thereby making the stuck ink readily swell.

(Water)

The water is ion exchange water, for example. The percentage content of the water is preferably at least 50% by mass and no greater than 95% by mass relative to the mass of the cleaning liquid, and more preferably at least 70% by mass and no greater than 85% by mass.

(Water-soluble Organic Solvent C)

The water-soluble organic solvent C is a water-soluble organic solvent other than glycol ether. Examples of the water-soluble organic solvent C include glycol compounds, lactam compounds, nitrogen-containing compounds, acetate compounds, thiodiglycol, glycerin, and dimethyl sulfoxide.

Examples of the glycol compounds include ethylene glycol, 1,2-propanediol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

An example of the acetate compounds is diethylene glycol monoethyl ether acetate.

The water-soluble organic solvent C is preferably glycerin or a glycol compound, and more preferably glycerin, 1,2-propanediol, 1,3-propanediol, or diethylene glycol.

In order to inhibit the cleaning liquid from remaining on the ejection surface in cleaning by adjusting the cleaning liquid viscosity within a desired value range, the percentage content of the water-soluble organic solvent C is preferably at least 1% by mass and no greater than 30% by mass relative to the mass of the cleaning liquid, and more preferably at least 5% by mass and no greater than 20% by mass. As a result of the percentage content of the water-soluble organic solvent C being set to no greater than 30% by mas relative to the mass of the cleaning liquid, the cleaning liquid viscosity can be easily adjusted to no greater than 10.0 mPa·s.

(Additional Component)

The cleaning liquid may further contain a known additive (specific examples include a solution stabilizer, an anti-drying agent, an antioxidant, a viscosity modifier, a pH adjuster, and antifungal agent) according to necessity.

(Cleaning liquid Production Method)

The cleaning liquid according to the first embodiment is produced by mixing water, the surfactant C, glycol ether, and a component to be added as necessary using a stirrer, for example.

(Cleaning Method Using Cleaning Liquid)

Supply of the cleaning liquid according to the first embodiment to the ejection surface of the recording head cleans the nozzle inner surfaces, the proximate area surfaces, and an area of the ejection surface other than the proximate area surfaces. Examples of the method for supplying the cleaning liquid to the ejection surface include supply of the cleaning liquid using a sponge or a sheet impregnated with the cleaning liquid, ejection of the cleaning liquid by inkjetting, application of the cleaning liquid using a roller, and spray of the cleaning liquid. After supply of the cleaning liquid, the ejection surface is preferably wiped using a wiping blade, for example. Note that the cleaning liquid according to the first embodiment can be used for washing members (e.g., a wiping blade and a conveyance roller) included in the inkjet recording apparatus other than the recording head.

### Second Embodiment: Inkjet Recording Apparatus Liquid Set

The second embodiment of the present disclosure relates to a inkjet recording apparatus liquid set (also referred to below as liquid set). The liquid set according to the second embodiment includes a first liquid and a second liquid. The first liquid is an ink. The second liquid is the cleaning liquid according to the first embodiment. As described previously, the cleaning liquid according to the first embodiment can favorably clean even an ink excellent in adhesion to the specific recording medium. The ink of the liquid set according to the second embodiment is excellent in adhesion to the specific recording medium, and the cleaning liquid of the liquid set according to the second embodiment can clean such an ink for the same reasons as those described in the first embodiment.

<Ink>

The following describes the ink that is the first liquid of the liquid set according to the second embodiment. The ink is a water-based ink containing water. The ink contains a pigment particles and water. Preferably, the ink further contains a first resin (pigment dispersion resin) attached to the surfaces of the pigment particles. Preferably, the ink further contains a second resin (binder resin) in a state of emulsified particles. The ink may further contain a surfactant, a water-soluble organic solvent, and an additional component as necessary. In the following, a “surfactant contained in the ink” and a “water-soluble organic solvent contained in the ink” may be also referred to below as “surfactant I” and water-soluble organic solvent I″, respectively.

(Pigment Particles)

Examples of a pigment constituting the pigment particles include a yellow pigment, an orange pigment, a red pigment, a blue pigment, a violet pigment, and a black pigment. Examples of the yellow pigment include C.I. Pigment Yellow 74, 93, 95, 109, 110, 120, 128, 138, 139, 151, 154, 155, 173, 180, 185, or 193. Examples of the orange pigment include C.I. Pigment Orange 34, 36, 43, 61, 63, or 71. Examples of the red pigment include C.I. Pigment Red 122 or 202. The red pigment may be quinacridonemagenta (PR122). Examples of the blue pigment include C.I. Pigment Blue 15 or 15:3. Examples of the violet pigment include C.I. Pigment Violet 19, 23, or 33. Examples of the black pigment include C.I. Pigment Black 4 or 7. The black pigment may be carbon black, for example.

The percentage content of the pigment particles is preferably at least 1% by mass and no greater than 8% by mass relative to the mass of the ink, and more preferably at least 1% by mass and no greater than 5% by mass. As a result of the percentage content of the pigment particles being set to at least 1% by mass relative to the mass of the ink, images with desired image density can be easily obtained. As a result of the percentage content of the pigment particles being set to no greater than 8% by mass relative to the mass of the ink, it is easy to ensure sufficient fluidity of the ink. This also makes it easy to form images with desired image density.

In order that the ink is excellent in color density and hue, the pigment particles preferably has a volume median diameter (D₅₀) of at least 30 nm and no greater than 200 nm, and more preferably at least 70 nm and no greater than 130 nm.

(First Resin)

The first resin is a pigment dispersion resin. The first resin is attached to the surfaces of the pigment particles. The first resin is attached to the surfaces of the pigment particles to function as a dispersant for dispersing the pigment particles in the ink. Note that a portion of the first resin may not be attached to the surfaces of the pigment particles and may be free in the ink.

Examples of the first resin include acrylic resin, styrene-acrylic resin, polyvinyl resin, polyester resin, amino resin, epoxy resin, urethane resin, polyether resin, polyamide resin, phenolic resin, silicone resin, fluororesin, styrene-maleic acid copolymers, styrene-maleic acid half-ester copolymers, vinylnaphthalene-acrylic acid copolymers, and vinylnaphthalene-maleic acid copolymers. The first resin is preferably acrylic resin or styrene-acrylic resin, and more preferably styrene-acrylic resin.

The acrylic resin is a polymer of (meth)acrylic acid or (meth)acrylic acid alkyl ester.

The styrene-acrylic resin is a copolymer of styrene and at least one selected from the group consisting of (meth)acrylic acid and (meth)acrylic acid alkyl ester. The styrene-acrylic resin is preferably a copolymer of styrene, (meth)acrylic acid, and (meth)acrylic acid alkyl ester. More preferably, the styrene-acrylic resin is a copolymer of styrene, (meth)acrylic acid, and (meth)acrylic acid alkyl ester having an alkyl group with a carbon number of at least 1 and no greater than 4. Particularly preferably, the styrene-acrylic resin is a copolymer of styrene, methacrylic acid, methyl methacrylate, and butyl acrylate.

The first resin preferably has anionicity. When the first resin has anionicity, the first resin may form a salt (e.g., sodium salt or potassium salt).

The first resin has a mass average molecular weight (Mw) of preferably at least 5000 and no greater than 100,000, and more preferably at least 15,000 and no greater than 25,000. The first resin has an acid value of preferably at least 50 mgKOH/g and no greater than 150 mgKOH/g, and more preferably at least 90 mgKOH/g and no greater than 110 mgKOH/g.

The first resin has a mass of at least 15 parts by mass and no greater than 100 parts by mass relative to 100 parts by mass of the pigment particles, and more preferably at least 20 parts by mass and no greater than 50 parts by mass. As a result of the mass of the first resin being set to at least 15 parts by mass relative to 100 parts by mass of the pigment particles, strike through in a formed image hardly occurs. As a result of the mass of the first resin being set to no greater than 100 parts by mass relative to 100 parts by mass of the pigment particles, images with desired image density can be easily obtained.

The first resin has a percentage content of at least 0.1% by mass and no greater than 3.0% by mass relative to the mass of the ink, and more preferably at least 0.1% by mass and no greater than 1.5% by mass. As a result of the percentage content of the first resin being set to at least 0.1% by mass relative to the mass of the ink, the ink can be excellent in preservation stability and stability in being ejected from a recording head. As a result of the percentage content of the first resin being set to no greater than 3.0% by mass relative to the mass of the ink, void defects in formed images tend to be inhibited.

(Second Resin)

The second resin is a binder resin for bonding the ink to a recording medium. The second resin differs from the first resin. Where the ink contains the second resin, the second resin is contained in the ink in a state of emulsified particles. That is, emulsified particles formed from the second resin are dispersed in the ink.

Examples of the second resin include thermoplastic resins. Examples of the thermoplastic resins include acrylic resin, styrene-acrylic resin, polyester resin, polyurethane, and polyolefin. In terms of the second resin being favorably dispersed in the ink and the ink favorably adhering to a recording medium, the second resin is preferably acrylic resin, polyurethane, or polyolefin.

In a case in which the specific recording medium is used as a recording medium, the second resin preferably has a percentage content to the mass of the ink of at least 0.9% by mass and no greater than 3.0% by mass. As a result of the percentage content of the second resin to the mass of the ink being set to no greater than 3.0% by mass, the ink is easily cleaned with the cleaning liquid and ejection failure and deviation of ejection from the recording head hardly occur. As a result of the percentage content of the second resin to the mass of the ink being set to at least 0.9% by mass, the ink readily adheres and fixes to the specific recording medium. Examples of the low-absorbency recording medium being the specific recording medium include art paper, coated paper, and cast-coated paper. Examples of the non-absorbency recording medium being the specific recording medium include foil paper, synthetic paper, and plastic base material. Examples of the plastic base material include a polyester (e.g., PET) base material, a polypropylene base material, a polystyrene base material, and a polyvinyl chloride base material.

In a case in which a recording medium (e.g., plain paper) other than the specific recording medium is used as a recording medium, the percentage content of the second resin is preferably greater than 0.0% by mass and less than 0.9% by mass. In a case in which a recording medium other than the specific recording medium is used as a recording medium and adhesion of the ink to the recording medium is sufficiently ensured, the ink may not contain the second resin. Examples of the recording medium other than the specific recording medium includes plain paper and high-quality paper.

(Water)

The water is ion exchange water, for example. In order that the ink can be stably ejected from the recording head, the percentage content of the water is preferably at least 30% by mass and no greater than 80% by mass relative to the mass of the ink, and more preferably at least 50% by mass and no greater than 65% by mass.

(Water-Soluble Organic Solvent I)

Examples of the water-soluble organic solvent I contained in the ink include the solvents listed as the examples of the water-soluble organic solvent C and the solvents listed as the examples of the glycol ether. Preferable examples of the water-soluble organic solvent I include glycol ether and glycol compounds. More preferably examples of the water-soluble organic solvent I include triethylene glycol monobutyl ether and 1,2-propanediol.

In order that the ink can be stably ejected from the recording head, the percentage content of the water-soluble organic solvent I is preferably at least 10% by mass and no greater than 65% by mass relative to the mass of the ink, and more preferably at least 15% by mass and no greater than 30% by mass.

(Surfactant I)

As a result of the ink containing the surfactant I, wettability of the ink to a recording medium increases. Examples of the surfactant I include an anionic surfactant, a cationic surfactant, and a nonionic surfactant. The surfactant I is preferably a nonionic surfactant.

Examples of the nonionic surfactant include polyoxyethylene dodecyl ether, polyoxyethylene hexadecyl ether, polyoxyethylene nonylphenyl ether, polyoxyethylene sorbitan monooleate ether, monodecanoyl sucrose, and ethylene oxide adducts of acetylene glycol. A preferable nonionic surfactant is an ethylene oxide adduct of acetylene glycol.

The surfactant I has an HLB value of preferably at least 3 and no greater than 20, more preferably at least 6 and no greater than 16, and further preferably at least 7 and no greater than 9.

The dynamic surface tension of an aqueous solution of 0.1% by mass of the surfactant I is preferably at least 20 mN/m and no greater than 50 mN/m, and more preferably at least 30 mN/m and no greater than 35 mN/m.

(Additional Component)

The ink may further contain a known additive (specific examples include a solution stabilizer, an anti-drying agent, an antioxidant, a viscosity modifier, a pH adjuster, and antifungal agent) according to necessity.

(Ink Production Method)

An ink production method includes preparing a pigment dispersion and mixing the pigment dispersion and the other ink components.

In the preparing a pigment dispersion, the pigment particles, water, and the first resin as necessary are kneaded using a disperser (e.g., a media disperser) to obtain a pigment dispersion.

In the mixing, the pigment dispersion and the other ink components (e.g., the second resin, water, the water-soluble organic solvent I, and the surfactant I) are mixed using a stirrer to obtain an ink. The ink that is the first liquid of the liquid set according to the second embodiment has been described so far.

### Examples

The following describes examples of the present disclosure. Note that in evaluation where errors occur, a significant number of measurement values that make the error sufficiently small were obtained and the arithmetic mean of the obtained measurement values was used as an evaluation value. Furthermore, “water” in the following means “ion exchange water”.

[Cleaning Liquid Preparation]

Cleaning liquids (CA-1) to (CA-17) of Examples and cleaning liquids (CB-1) to (CB-8) of Comparative Examples were prepared. The components contained in each of the cleaning liquids and their blending ratios are shown below in Tables 3 to 7.

<Preparation of Cleaning Liquid (CA-1)>

A beaker was charged with 1.0 parts by mass of a surfactant S1 (silicone surfactant, product of Nissin Chemical Industry Co., Ltd., “SILFACE SAG503A”), 1.0 parts by mass of a surfactant X3 (betaine surfactant, product of DKS Co. Ltd., “AMOGEN (registered Japanese trademark) CB-H”), 10.0 parts by mass of 1,2-propanediol, 10.0 parts by mass of triethylene glycol monobutyl ether, and the remaining amount of water. Note that the remaining amount means an amount that makes the total mass of the components contained in a cleaning liquid 100.0 parts by mass. In the preparation of the cleaning liquid (CA-1), the remaining amount was 78.0 parts by mass (=100.0−(1.0+1.0+10.0+10.0)). The beaker contents were stirred at a rotational speed 400 rpm using a stirrer (product of Shinto Scientific Co., Ltd., “THREE-ONE MOTOR BL-600”) until the beaker contents became homogenous. Through the above, a cleaning liquid (CA-1) was obtained.

<Preparation of Cleaning Liquids (CA-2) to (CA-17) and (CB-1) to (CB-8)>

Cleaning liquids (CA-2) to (CA-17) and (CB-1) to (CB-8) were prepared according to the same method as that for preparing the cleaning liquid (CA-1) in all aspect other than use of the components shown in Tables 3 to 7 in their blending ratios shown in Tables 3 to 7.

[Pigment Dispersion Preparation]

Pigment dispersions (C), (Y), (M), and (BK) for use in ink preparation were prepared. Table 1 shows the respective components contained in the pigment dispersions and their blending ratios.

TABLE 1

| Pigment dispersion | | C | Y | M | BK |
|---|---|---|---|---|---|
| Blending ratio | Water | 80 | 80 | 80 | 80 |
| (% by mass) | Resin A-Na | 5 | 5 | 5 | 5 |
| | Cyan pigment | 15 | — | — | — |
| | Yellow pigment | — | 15 | — | — |
| | Magenta pigment | — | — | 15 | — |
| | Black pigment | — | — | — | 15 |
| | Total | 100 | 100 | 100 | 100 |

Meanings of the terms indicated in Table 1 are as follows.
Cyan pigment: C.I. Pigment Blue 15:3
Yellow pigment: C.I. Pigment Yellow 74
Magenta pigment: C.I. Pigment Red 122
Black pigment: C.I. Pigment Black 4
Resin A-Na: resin A neutralized with sodium hydroxide (NaOH)

<Preparation of Resin A>

A resin A for obtaining the “resin A-Na” in Table 1 was prepared according to the following method. In detail, a stirrer, a nitrogen inlet tube, a condenser (stirrer), and a dropping funnel were set at a four-necked flask. Next, 100 parts by mass of isopropyl alcohol and 300 parts by mass of methyl ethyl ketone were added into the flask. Heat refluxing at 70° C. was carried out on the flask contents under bubbling of nitrogen into the flask contents.

Next, a solution 1 L was prepared. In detail, 40.0 parts by mass of styrene, 10.0 parts by mass of methacrylic acid, 40.0 parts by mass of methyl methacrylate, 10.0 parts by mass of butyl acrylate, and 0.4 parts by mass of azobisisobutyronitrile (AIBN, polymerization initiator) were mixed to obtain a solution L1 being a monomer solution. The solution L1 was dripped into the flask over 2 hours while heat refluxing at 70° C. was carried out on the flask contents. After the dripping, heat refluxing at 70° C. was further carried out on the flask contents for 6 hours.

Next, a solution L2 was prepared. In detail, 0.2 parts by mass of AIBN and methyl ethyl ketone were mixed to obtain a solution L2. The solution L2 was dripped into the flask over 15 minutes. After the dripping, heat refluxing at 70° C. was further carried out on the flask contents for 5 hours. Through the above, a resin A (styrene-acrylic resin) was obtained. The resultant resin A had a mass average molecular weight (Mw) of 20,000 and an acid value of 100 mgKOH/g.

Here, the mass average molecular weight Mw of the resin A was measured using a gel filtration chromatography (product of Tosoh Corporation, “HLC-8020GPC”) under the following conditions.

Column: product of Tosoh Corporation, “TSKgel SUPERMULTIPORE HZ-H” (semi-micro column with 4.5 mm I.D.×15 cm)

Number of columns: 3

Eluent: tetrahydrofuran

Flow rate: 0.35 mL/min.

Sample ejection amount: 10 μL

Measurement temperature: 40° C.

Detector: IR detector

Calibration curves were plotted for n-propyl benzene and seven materials F-40, F-20, F-4, F-1, A-5000, A-2500, and A-1000 selected from TSKgel Standard polystyrene produced by Tosoh Corporation.

Furthermore, the acid value of the resin A was measured by a method in accordance with the method prescribed in “Japanese Industrial Standards (JIS) K0070-1992 (Test methods for acid value, saponification value, ester value, iodine value, hydroxyl value and unsaponifiable matter of chemical products)”.

<Preparation of Pigment Dispersion (C)>

A sodium hydroxide aqueous solution in an amount necessary for neutralization of the resin A was added to the resin A while the resin A was heated in a warm bath at 70° C. Specifically, a sodium hydroxide aqueous solution in a mass of 1.1 times the neutralization equivalent was added to the resin A. Through the above, an aqueous solution of the resin A (resin A-Na) neutralized with sodium hydroxide was obtained. The aqueous solution of the resin A-Na had a pH of 8.

A vessel of a media type disperser (product of Willy A. Bachofen A G, “DYNO (registered Japanese trademark) MILL”) was charged with 5 parts by mass of the resin A-Na, 15 parts by mass of C.I. Pigment Blue 15:3, and 80 parts by mass of water so that the respective blending ratios were as indicated in Table 1. Note that the water was added so that the mass of the added water was 80 parts by mass including the mass of the water contained in the sodium hydroxide aqueous solution used for neutralization of the resin A and the mass of the water produced through the neutralization reaction.

Next, a medium (zirconia beads with a diameter of 1.0 mm) was added into the vessel so that the fill rate of the medium was 70% by volume relative to the capacity of the vessel. The vessel contents were dispersed using the media type disperser. Through the above, a pigment dispersion (C) being a pigment dispersion for cyan ink use was obtained.

The pigment dispersion (C) was diluted 300 times with water to obtain a dilution. The dilution was measured using a dynamic light scattering type particle size distribution analyzer (product of SYSMEX CORPORATION, “ZETASIZER NANO ZS”) to determine a volume median diameter (D₅₀) of the pigment particles contained in the pigment dispersion (C). It was confirmed that the pigment particles with a volume median diameter of at least 70 nm and no greater than 130 nm have been dispersed in the pigment dispersion (C).

<Preparation of Pigment Dispersions (Y), (M), and (BK)>

Pigment dispersions (Y), (M), and (BK) were prepared according to the same method as that for preparing the pigment dispersion (C) in all aspects other than use of the components shown in Table 1 in their blending ratios shown in Table 1. The pigment dispersions (Y), (M), and (BK) were pigment dispersions for yellow ink use, magenta ink use, and black ink used, respectively.

[Ink Preparation]

Inks (I-1) to (I-5) to be used for liquid sets were prepared. Table 2 shows the components contained in each of the inks and their blending ratios.

TABLE 2

| Inks | | | 1-1 | 1-2 | 1-3 | 1-4 | 1-5 |
|---|---|---|---|---|---|---|---|
| Blending ratio | Water | | Rest | Rest | Rest | Rest | Rest |
| (% by mass) | Pigment dispersion | | 15.0 | 15.0 | 15.0 | 15.0 | 15.0 |
| | Resin emulsion R1 | Amount | 5.0 | — | — | 3.0 | 10.0 |
| | | Solid content mass | 1.5 | — | — | 0.9 | 3.0 |
| | Resin emulsion R2 | Amount | — | 5.0 | — | — | — |
| | | Solid content mass | — | 2.3 | — | — | — |
| | Resin emulsion R3 | Amount | — | — | 5.0 | — | — |
| | | Solid content mass | — | — | 1.5 | — | — |
| | Surfactant A3 | Amount | 1.0 | 1.0 | 1.0 | 1.0 | 1.0 |
| | | Effective component amount | 1.0 | 1.0 | 1.0 | 1.0 | 1.0 |

| | | | | | |
|---|---|---|---|---|---|
| 1,2-Propanediole | 10.0 | 10.0 | 10.0 | 10.0 | 10.0 |
| Triethylene glycol monobutyl ether | 10.0 | 10.0 | 10.0 | 10.0 | 10.0 |
| Total | 100.0 | 100.0 | 100.0 | 100.0 | 100.0 |

Meanings of the terms indicated in Table 2 are as follows.
Rest: amount which made the total mass of the components contained in corresponding ink 100.0 parts by mass
Pigment dispersion: pigment dispersion obtained in [Pigment Dispersion Preparation] described above
Resin emulsion R1: polyurethane emulsion (product of Ube Industries, Ltd., “ETERNACOLL (registered Japanese trademark) UW-5002E”, solid concentration: 30% by mass, dispersion medium: water)
Resin emulsion R2: acrylic resin emulsion (product of Japan Coating Resin Corporation, “MOWINYL (registered Japanese trademark) 6820”, solid concentration: 45% by mass, dispersion medium: water)
Resin emulsion R3: polyolefin-modified emulsion (product of Mitsubishi Chemical Corporation, “APTOLOK (registered Japanese trademark) BW-5635, solid concentration: 30% by mass, dispersion medium: water)
Amount: additive amount of corresponding resin emulsion
Solid content mass: mass (i.e., mas of resin, unit: % by mass) of solid content contained in corresponding resin emulsion (the solid content amount was calculated using an equation “solid content amount=additive amount of resin emulsion×(solid concentration/100)”).
Surfactant A3: described later in explanation of terms indicated in Tables 3 to 7

<Preparation of Ink (I-1)>

Inks (I-1) were inks in four colors including a cyan ink (I-1), a yellow ink (I-1), a magenta ink (I-1), and a black ink (I-1). In the following, the inks (I-1) in four colors may be simply referred to as “inks (I-1)”.

(Preparation of Cyan Ink (I-1)>

Respective components were added into a beaker so that the blending ratios thereof were those indicated in the column titled “(I-1)” for “Inks” in Table 2. In detail, the remaining amount of water, 15.0 parts by mass of the pigment dispersion (C), 5.0 parts by mass of the resin emulsion R1, 1.0 parts by mass of the surfactant A3, 10.0 parts by mass of 1,2-propanediol, and 10.0 parts by mass of tirethylene glycol monobutyl ether were added into a beaker. In the preparation of the cyan ink (I-1), the remaining amount was 59.0 parts by mass (=100.0−(15.0+5.0+1.0+10.0+10.0)). The beaker contents were mixed at a rotational speed 400 rpm using a stirrer (product of Shinto Scientific Co., Ltd., “THREE-ONE MOTOR BL-600”) for mixing the beaker contents to obtain a mixed liquid. The mixed liquid was filtered using a filter (opening 5 μm) to remove foreign matter and coarse particles contained in the mixed liquid. Through the above, a cyan ink (I-1) was obtained.

(Preparation of Yellow Ink (I-1), Magenta Ink (I-1), and Black Ink (I-1))

A yellow ink (I-1) was prepared according to the same method as that for preparing the cyan ink (I-1) in all aspects other than change from the pigment dispersion (C) to the pigment dispersion (Y). A magenta ink (I-1) was prepared according to the same method as that for preparing the cyan ink (I-1) in all aspects other than change from the pigment dispersion (C) to the pigment dispersion (M). A black ink (I-1) was prepared according to the same method as that for preparing the cyan ink (I-1) in all aspects other than change from the pigment dispersion (C) to the pigment dispersion (BK).

<Preparation of Inks (I-2)>

Inks (I-2) in four colors were prepared according to the same method as that for preparing the inks (I-1) in four colors in all aspects other than use of the components indicated in the column titled “(I-2)” for “Inks” in Table 2 in their blending ratios indicated in the same column. In the following, the inks (I-2) in four colors may be simply referred to as “inks (I-2)”.

<Preparation of Ink (I-3)>

Inks (I-3) in four colors were prepared according to the same method as that for preparing the inks (I-1) in four colors in all aspects other than use of the components indicated in the column titled “(I-3)” for “Inks” in Table 2 in their blending ratios indicated in the same column. In the following, the inks (I-3) in four colors may be simply referred to as “inks (I-3)”.

<Preparation of Ink (I-4)>

Inks (I-4) in four colors were prepared according to the same method as that for preparing the inks (I-1) in four colors in all aspects other than use of the components indicated in the column titled “(I-4)” for “Inks” in Table 2 in their blending ratios indicated in the same column. In the following, the inks (I-4) in four colors may be simply referred to as “inks (I-4)”.

<Preparation of Ink (I-5)>

Inks (I-5) in four colors were prepared according to the same method as that for preparing the inks (I-1) in four colors in all aspects other than use of the components indicated in the column titled “(I-5)” for “Inks” in Table 2 in their blending ratios indicated in the same column. In the following, the inks (I-5) in four colors may be simply referred to as “inks (I-5)”.

[Measurement]

<Measurement of Cleaning Liquid Viscosity>

The viscosity of each cleaning liquid was measured by a method in accordance with “JIS Z 8803:2011 (Methods for viscosity measurement of liquid)” in an environment at 25° C. Measurement results are shown in Tables 3 to 7.

<Measurement of Cleaning liquid Contact Angle>

Any of the cleaning liquids (CA-1) to (CA-17) and (CB-1) to (CB-8) was dripped onto a SUS304 plate in an environment at 25° C. using a contact angle measurement device (product of EKO Instruments Co., Ltd., “OCA40”). After 1 second from deposition of the cleaning liquid on the SUS304 plate, the contact angle of the droplet of the cleaning liquid relative to the SUS304 plate was measured using the contact angle measurement device. The SUS304 plate used was a plate obtained by cutting a SUS304 plate (product of OEM Co., Ltd., thickness 0.05 mm, length 300 mm, width 200 mm) into a size of 5 mm in length and 5 mm in width. Measurement results are shown in Tables 3 to 7.

[Evaluation]

An inkjet recording apparatus (prototype produced by KYOCERA Document Solutions Japan Inc.) including four recording heads was used as an evaluation apparatus in the following evaluations. The four recording heads corresponded to the respective colors and each were a piezoelectric line head with 2656 nozzles. The amount of a droplet was set to 10 pL and the drive frequency was set to 20 kHz.

Any inks (inks in four colors) indicated in Tables 3 to 7 were loaded in the ink tanks for the respective corresponding colors, and the ejection surfaces of the recording heads were cleaned with any of the cleaning liquids indicated in Tables 3 to 7. For example, in evaluation for Example 1, the inks (I-1) (e.g., the inks in four colors of the cyan ink (I-1), the yellow ink (I-1), the magenta ink (I-1), and the black ink (I-1)) were loaded into the ink tanks for the respective corresponding colors. Then, the ejection surfaces of the recording heads were cleaned with the cleaning liquid (CA-1) indicated in Table 3.

<Evaluation of Cleaning Ability>

Evaluation of cleaning ability with respect to the ejection surfaces of the recording heads was carried out in a normal-temperature and normal-humidity environment (environment at a temperature of 25° C. and a relative humidity of 60%). The following operation was repeated 20 times. That is, a solid image (printing rate 100%, A4 size) was consecutively printed on 9000 sheets of paper (product of Xerox Corporation, “P”) using the evaluation apparatus. After the printing, purging, first-time cleaning liquid supply, first-time wiping, second-time cleaning liquid supply, and second-time wiping were carried out in the stated order. In the purging, the respective inks were purged from the four recording heads. In each of the first-time cleaning liquid supply and the second-time cleaning liquid supply, sheets (cut pieces obtained by cutting a sheet (product of Asahi Kasei Corp., “BEMCOT (registered Japanese trademark) M-3II”) into the same size as that of the ejection surfaces) soaked with 3 mL of the cleaning liquid was made in contact with the respective ejection surfaces of the four recording heads for 30 seconds. In each of the first-time wiping and the second-time wiping, the respective ejection surfaces of the four recording heads were wiped using the wiping blades of the evaluation apparatus. The above series of operations was repeated 20 times. Next, the ejection surfaces were observed at an observation magnification of 50× using a microscope to check the presence or absence of unwiped residual ink. Cleaning ability of each ink was evaluated according to the following criteria. Measurement results are shown in Tables 3 to 7.

(Criteria for Cleaning Ability)

A (particularly good): no ink at all was adhered to the ink ejection surfaces.

B (good): a slight amount of ink was adhered to the ink ejection surfaces.

C (poor): ink was definitely adhered to the ink ejection surfaces.

<Evaluation of Accuracy of Ink Placement>

Evaluation of accuracy of ink placement was carried out in a normal-temperature and normal-humidity environment (environment at a temperature of 25° C. and a relative humidity of 60%). First, dot rows were formed by ejecting one droplet of a corresponding color from each of all the nozzles of the four recording heads toward one sheet of paper (product of Fuji Xerox Co., Ltd., “C²”, A4-size plain paper) using the evaluation apparatus before the evaluation of cleaning ability described above. The paper with the dot rows formed thereon was taken to be first evaluation paper. Next, dot rows were formed by the same method as above using the evaluation apparatus after the evaluation of cleaning ability described above and the paper with the dot rows formed thereon was taken to be second evaluation paper.

The first evaluation paper and the second evaluation paper were observed using an image analyzer (product of Oji Scientific Instruments Co., Ltd., “High-speed High-definition Image Processing Analysis System DOT ANALYZER DA-6000”) to check the presence or absence of artifact of the dot rows. Specifically, with respect to each of 2656 cyan ink dots, 2656 yellow ink dots, 2656 magenta ink dots, and 2656 black ink dots formed on the evaluation paper, a displacement width of the dot in the transverse direction (widthwise direction) of each evaluation paper and a displacement width of the dot in the longitudinal direction (lengthwise direction) of each evaluation paper were measured. From the measurement results, a number average value (3σx, unit: μm) of the displacement widths of the dot in the transverse direction of each evaluation paper and a number average value (3σy, unit: μm) of the displacement widths of the dot in the longitudinal direction of each evaluation paper were calculated. A displacement width 3σ (unit: μm) of the dot rows formed on each evaluation paper was calculated using an equation “3σ=3√[(σx)²+(σy)²]”. Then, a change amount 436 (unit: μm) in dot row displacement width between before and after the evaluation of cleaning ability described above was calculated using an equation “Δ3σ=|(3σ of first evaluation paper)−(3σ of second evaluation paper)|”. Accuracy of ink placement was evaluated according to the following criteria. Measurement results are shown in Tables 3 to 7. Note that the presence or absence of finer stuck ink can be determined in the evaluation of accuracy of ink placement than in the evaluation of cleaning ability described above. The more favorable the accuracy of ink placement is, the more favorably stuck ink around the nozzle inner surfaces and the proximate area surfaces tends to be cleaned. Furthermore, the more favorable accuracy of ink placement is, the more hardly the water-repellent films of the nozzle surfaces tend to peel off and the more favorably stuck ink on the nozzle surfaces tends to be cleaned.

(Criteria for Accuracy of Ink Placement)

A (good): change amount A3σ of less than 3 μm

B (poor): change amount A3σ of at least 3 μm

<Evaluation of Adhesion>

A solid image (printing rate 100%) was printed on a PET sheet (polyester film, product of Toray Industries, Inc., “LUMIRROR (registered Japanese trademark) S10 #50”) using the evaluation apparatus. The printed sheet was heated at 120° C. for 30 seconds to dry the ink. The resultant sheet was taken to be an evaluation sheet. Six 2-mm spaced lattice-like (grid-like) incisions in each of the vertical direction and the horizontal direction were made in the image on the evaluation sheet to form 25 square-shaped cells of 2 mm per side. The 25 cells were formed at four locations in the formed image to form 100 cells in total. Adhesive tape (product of Nichiban Co., Ltd., “CELLOTAPE (registered Japanese trademark) CT-24”) was attached onto the image with the incisions formed therein, and peeled off at an angle of approximately 60 degrees. The peeling off of the adhesive tape was carried out at a speed that took 1 second from the peeling start to the peeling end. After the peeling off of the adhesive tape, the surface of the evaluation sheet from which the adhesive tape has been peeled off was observed and the number of unpeeled and remaining cells was counted. Ink adhesion was evaluated according to the following criteria. Measurement results are shown in Tables 3 to 7.

(Criteria for Adhesion)

A (good): cell remaining rate of at least 90% by number

B (poor): cell remaining rate of less than 90% by number

The following explains the terms in Tables 3 to 7.
Surfactant SI: silicone surfactant (product of Nissin Chemical Industry Co., Ltd., “SILFACE SAG503A”, effective component: polyether-modified polydimethylsiloxane, effective component concentration: 100% by mass, iconicity: nonionic surfactant, HLB value: 11, dynamic surface tension of 0.1% by mass aqueous solution: 37 mN/m)
Surfactant S2: silicone surfactant (product of Nissin Chemical Industry Co., Ltd., “SILFACE SAG014”, effective component: polyether-modified organosiloxane, effective component concentration: 100% by mass, iconicity: nonionic surfactant, HLB value: 11)
Surfactant S3: silicone surfactant (product of BYK CHEMIE Japan, KK, “BYK-3450”, effective component: polyether-modified polydimethylsiloxane, effective component concentration: 100% by mass
Surfactant X1: betaine surfactant (product of New Japan Chemical Co., Ltd., “RIKABION B-200”, effective component: coconut oil fatty acid amide propyl betaine, effective component concentration: 30.5% by mass, iconicity: amphoteric surfactant)
Surfactant X2: betaine surfactant (product of New Japan Chemical Co., Ltd., “RIKABION A-100”, effective component: lauryl dimethylamino acetate betaine, effective component concentration: 30.5% by mass, iconicity: amphoteric surfactant)
Surfactant X3: betaine surfactant (product of DKS Co. Ltd., “AMOGEN (registered Japanese trademark) CB-H”, effective component: amide betaine, effective component concentration: 30% by mass, ionicity: amphoteric surfactant)
Surfactant A1: acetylene surfactant (product of Nissin Chemical Industry Co., Ltd., “OLFINE (registered Japanese trademark) E1010P, effective component: ethylene oxide adduct of acetylene diol, effective component concentration: 100% by mass, ionicity: nonionic surfactant, HLB value: 13.5, dynamic surface tension of 0.1% by mass aqueous solution: 39 mN/m)
Surfactant A2: acetylene surfactant (product of Nissin Chemical Industry Co., Ltd., “OLFINE (registered Japanese trademark) EXP4300”, effective component: ethylene oxide adduct of acetylene diol, effective component concentration: 60% by mass, solvent: propylene glycol and dipropylene glycol, ionicity: nonionic surfactant, dynamic surface tension of 0.1% by mass aqueous solution: 26 mN/m)
Surfactant A3: acetylene surfactant (product of Nissin Chemical Industry Co., Ltd., “SURFYNOL (registered Japanese trademark) 440”, effective component: ethylene oxide adduct of acetylene glycol, effective component concentration: 100% by mass, inonicity: nonionic surfactant, HLB value: 8, dynamic surface tension of 0.1% by mass aqueous solution: 32 mN/m)
-: no use of corresponding component
Rest: being amount which made the total mass of components contained in corresponding cleaning liquid 100.0 parts by mass
Viscosity: viscosity (unit: mPa·s) of corresponding cleaning liquid
Contact angle: contact angle (unit: degree) of corresponding cleaning liquid relative to SUS304 plate
NG: poor

Note that in the column for each blending ratio of the surfactants in Tables 3 to 7, the unparenthesized numeral indicates an additive amount (unit: % by mass) of a corresponding surfactant and the parenthesized numeral indicates an effective component amount of a corresponding surfactant (i.e., a substantial mass of a corresponding surfactant). The effective component amounts are each calculated using an equation “effective component amount=additive amount of surfactant×(effective component concentration/100)”.

TABLE 3

| | | Example 1 | Example 2 | Example 3 | Example 4 | Example 5 |
|---|---|---|---|---|---|---|
| Liquid set | | LA-1 | LA-2 | LA-3 | LA-4 | LA-5 |
| Inks | | I-1 | I-1 | I-1 | I-1 | 1-1 |
| Cleaning liquid | | CA-1 | CA-2 | CA-3 | CA-4 | CA-5 |
| Blending | Water | Rest | Rest | Rest | Rest | Rest |
| ratio | Surfactant S1 | 1.0 (1.0) | 1.0 (1.0) | 1.0 (1.0) | 1.0 (1.0) | 1.0 (1.0) |
| (% by mass) | Surfactant S2 | — | — | — | — | — |
| | Surfactant S3 | — | — | — | — | — |
| | Surfactant X1 | — | — | — | — | — |
| | Surfactant X2 | — | — | — | — | — |
| | Surfactant X3 | 1.0 (0.3) | 1.0 (0.3) | 1.0 (0.3) | 1.0 (0.3) | 1.0 (0.3) |
| | Surfactant A1 | — | — | — | — | — |
| | Surfactant A2 | — | — | — | — | — |
| | Surfactant A3 | — | — | — | — | — |
| | 1,2-Propanediol | 10.0 | 10.0 | 10.0 | — | — |
| | 1,3-Propanediol | — | — | — | 10.0 | — |
| | Glycerin | — | — | — | — | 10.0 |
| | Diethylene glycol | — | — | — | — | — |
| | Triethylene glycol monobutyl ether | 10.0 | 5.0 | 15.0 | 10.0 | 10.0 |
| | Diethylene glycol monoethyl ether | — | — | — | — | — |
| | Dipropylene glycol monomethyl ether | — | — | — | — | — |
| | Total | 100.0 | 100.0 | 100.0 | 100.0 | 100.0 |
| Viscosity(mPa · s) | | 3.5 | 3.0 | 4.0 | 3.0 | 4.0 |
| Contact angle(Degree) | | 24 | 22 | 25 | 24 | 23 |
| Evaluation | Cleaning ability | A | A | A | A | A |
| | Accuracy of ink placement | A | A | A | A | A |
| | Adhesion | A | A | A | A | A |

TABLE 4

| | | Example 6 | Example 7 | Example 8 | Example 9 | Example 10 |
|---|---|---|---|---|---|---|
| Liquid set | | LA-6 | LA-7 | LA-8 | LA-9 | LA-10 |
| Inks | | 1-1 | 1-1 | 1-2 | 1-3 | 1-1 |
| Cleaning liquid | | CA-6 | CA-7 | CA-8 | CA-9 | CA-10 |
| Blending ratio | Water | Rest | Rest | Rest | Rest | Rest |
| (% by mass) | Surfactant S1 | 1.0 (1.0) | 1.0 (1.0) | 1.0 (1.0) | 1.0 (1.0) | — |
| | Surfactant S2 | — | — | — | — | — |
| | Surfactant S3 | — | — | — | — | 1.0 (1.0) |
| | Surfactant X1 | — | — | — | — | — |
| | Surfactant X2 | — | — | — | — | — |
| | Surfactant X3 | 1.0 (0.3) | 1.0 (0.3) | 1.0 (0.3) | 1.0 (0.3) | 1.0 (0.3) |
| | Surfactant A1 | — | — | — | — | — |
| | Surfactant A2 | — | — | — | — | — |
| | Surfactant A3 | — | — | — | — | — |
| | 1,2-Propanediol | 10.0 | 10.0 | 10.0 | 10.0 | 10.0 |
| | 1,3-Propanediol | — | — | — | — | — |
| | Glycerin | — | — | — | — | — |
| | Diethylene glycol | — | — | — | — | — |
| | Triethylene glycol monobutyl ether | — | — | 10.0 | 10.0 | 10.0 |
| | Diethylene glycol monoethyl ether | 10.0 | — | — | — | — |
| | Dipropylene glycol monomethyl ether | — | 10.0 | — | — | — |
| | Total | 100.0 | 100.0 | 100.0 | 100.0 | 100.0 |
| Viscosity(mPa · s) | | 3.5 | 3.0 | 3.5 | 3.5 | 3.5 |
| Contact angle(Degree) | | 24 | 24 | 24 | 24 | 24 |
| Evaluation | Cleaning ability | A | A | A | A | A |
| | Accuracy of oink placement | A | A | A | A | A |
| | Adhesion | A | A | A | A | A |

TABLE 5

| | | Example 11 | Example 12 | Example 13 | Example 14 | Example 15 |
|---|---|---|---|---|---|---|
| Liquid set | | LA-11 | LA-12 | LA-13 | LA-14 | LA-15 |
| Inks | | 1-1 | 1-1 | 1-1 | 1-4 | 1-5 |
| Cleaning liquid | | CA-11 | CA-12 | CA-13 | CA-14 | CA-15 |
| Blending ratio | Water | Rest | Rest | Rest | Rest | Rest |
| (% by mass) | Surfactant S1 | — | 1.0 (1.0) | 1.0(1.0) | 1.0 (1.0) | 1.0 (1.0) |
| | Surfactant S2 | 1.0 (1.0) | — | — | — | — |
| | Surfactant S3 | — | — | — | — | — |
| | Surfactant X1 | — | — | 1.0 (0.3) | — | — |
| | Surfactant X2 | | 1.0 (0.3) | — | — | — |
| | Surfactant X3 | 1.0 (0.3) | — | — | 1.0 (0.3) | 1.0 (0.3) |
| | Surfactant A1 | — | — | — | — | — |
| | Surfactant A2 | — | — | — | — | — |
| | Surfactant A3 | — | — | — | — | — |
| | 1,2-Propanediol | 10.0 | 10.0 | 10.0 | 10.0 | 10.0 |
| | 1,3-Propanediol | — | — | — | — | — |
| | Glycerin | — | — | — | — | — |
| | Diethylene glycol | — | — | — | — | — |
| | Triethylene glycol monobutyl ether | 10.0 | 10.0 | 10.0 | 10.0 | 10.0 |
| | Diethylene glycol monoethyl ether | — | — | — | — | — |
| | Dipropylene glycol monomethyl ether | — | — | — | — | — |
| | Total | 100.0 | 100.0 | 100.0 | 100.0 | 100.0 |
| Viscosity(mPa · s) | | 3.5 | 3.5 | 3.5 | 3.0 | 4.0 |
| Contact angle(Degree) | | 24 | 25 | 25 | 24 | 24 |
| Evaluation | Cleaning ability | A | A | A | A | A |
| | Accuracy of ink placement | A | A | A | A | A |
| | Adhesion | A | A | A | A | A |

TABLE 6

| | | | | Comparative | Comparative | Comparative |
|---|---|---|---|---|---|---|
| | | Example 16 | Example 17 | Example 1 | Example 2 | Example 3 |
| Liquid set | | LA-16 | LA-17 | LB-1 | LB-2 | LB-3 |
| Inks | | 1-1 | 1-1 | 1-1 | 1-1 | 1-1 |
| Cleaning liquid | | CA-16 | CA-17 | CB-1 | CB-2 | CB-3 |
| Blending ratio | Water | Rest | Rest | Rest | Rest | Rest |
| (% by mass) | Surfactant SI | 0.5 (0.5) | 1.5 (1.5) | 1.0(1.0) | 1.0 (1.0) | — |
| | Surfactant S2 | — | — | — | — | — |
| | Surfactant S3 | — | — | — | — | — |
| | Surfactant XI | — | — | — | — | 1.0 (0.3) |
| | Surfactant X2 | — | — | — | — | — |
| | Surfactant X3 | 0.5 (0.2) | 1.5(05) | 1.0 (0.3) | 1.0 (0.3) | — |
| | Surfactant Al | — | — | — | — | — |
| | Surfactant A2 | — | — | — | — | 1.0 (0.6) |
| | Surfactant A3 | — | — | — | — | — |
| | 1,2-Propanediol | 10.0 | 10.0 | 10.0 | 10.0 | 10.0 |
| | 1,3-Propanediol | — | — | — | — | — |
| | Glycerin | — | — | — | — | — |
| | Diethylene glycol | — | — | — | — | — |
| | Triethylene glycol monobutyl ether | 10.0 | 10.0 | 3.0 | 20.0 | 10.0 |
| | Diethylene glycol monoethyl ether | — | — | — | — | — |
| | Dipropylene glycol monomethyl ether | — | — | — | — | — |
| | Total | 100.0 | 100.0 | 100.0 | 100.0 | 100.0 |
| Viscosity(mPa · s) | | 3.5 | 3.7 | 3.0 | 4.0 | 3.5 |
| Contact angle(Degree) | | 25 | 22 | 22 | 35 | 33 |
| Evaluation | Cleaning ability | A | A | C (NG) | C (NG) | C (NG) |
| | Accuracy of ink placement | A | A | B (NG) | B (NG) | B (NG) |
| | Adhesion | A | A | A | A | A |

TABLE 7

| | | Comparative | Comparative | Comparative | Comparative | Comparative |
|---|---|---|---|---|---|---|
| | | Example 4 | Example 5 | Example 6 | Example 7 | Example 8 |
| Liquid set | | LB-4 | LB-5 | LB-6 | LB-7 | LB-8 |
| Inks | | 1-1 | 1-1 | 1-1 | 1-1 | 1-1 |
| Cleaning liquid | | CB-4 | CB-5 | CB-6 | CB-7 | CB-8 |
| Blending ratio | Water | Rest | Rest | Rest | Rest | Rest |
| (% by mass) | Surfactant S1 | 1.0 (1.0) | — | — | — | 1.0 (1.0) |
| | Surfactant S2 | — | — | — | — | — |
| | Surfactant S3 | — | — | — | — | — |
| | Surfactant X1 | — | — | — | — | — |
| | Surfactant X2 | — | — | — | — | — |
| | Surfactant X3 | 1.0 (0.3) | 1.0 (0.3) | 1.0 (0.3) | 1.0 (0.3) | — |
| | Surfactant A1 | — | 1.0 (1.0) | — | — | — |
| | Surfactant A2 | — | — | 1.0 (0.6) | — | — |
| | Surfactant A3 | — | — | | 1.0 (1.0) | |
| | 1,2-Propanediol | 40.0 | 10.0 | 10.0 | 10.0 | 10.0 |
| | 1,3-Propanediol | — | — | — | — | — |
| | Glycerin | — | — | — | — | — |
| | Diethylene glycol | — | — | — | — | — |
| | Triethylene glycol monobutyl ether | 5.0 | 10.0 | 10.0 | 10.0 | 10.0 |
| | Diethylene glycol monoethyl ether | — | — | — | — | — |
| | Dipropylene glycol monomethyl ether | — | — | — | — | — |
| | Total | 100.0 | 100.0 | 100.0 | 100.0 | 100.0 |
| Viscosity (mPa · s) | | 12.0 | 3.5 | 3.5 | 3.5 | 3.5 |
| Contact angle (Degree) | | 39 | 30 | 30 | 32 | 25 |
| Evaluation | Cleaning ability | C (NG) | C (NG) | C (NG) | C (NG) | C (NG) |
| | Accuracy of ink placement | B (NG) | A | A | A | B (NG) |
| | Adhesion | A | A | A | A | A |

As shown in Tables 6 and 7, the percentage content of the glycol ether in the cleaning liquid (CB-1) was less than 5.0% by mass relative to the mass of the cleaning liquid. The percentage content of the glycol ether in the cleaning liquid (CB-2) was greater than 15% by mas relative to the mass of the cleaning liquid. The cleaning liquid (CB-3) contained no silicone surfactants. The cleaning liquid (CB-4) had a viscosity of greater than 10.0 mPa·s. The cleaning liquids (CB-5) to (CB-7) contained no silicone surfactants. The cleaning liquid (CB-8) contained no betaine surfactants. As a result, either or both accuracy of ink placement and cleaning ability of the ejection surfaces of the recording heads were evaluated as poor when any of the cleaning liquids (CB-1) to (CB-8) was used.

By contrast, as shown in Tables 3 to 6, the cleaning liquids (CA-1) to (CA-17) had the following features. That is, the surfactant included both a silicone surfactant and a betaine surfactant. The glycol ether had a percentage content of at least 5.0% by mass and no greater than 15.0% by mass relative to the mass of the cleaning liquid. The cleaning liquid had a viscosity of no greater than 10.0 mPa·s. As a result, both accuracy of ink placement and cleaning ability of the ejection surfaces of the recording heads were evaluated as good when any of the cleaning liquids (CA-1) to (CA-17) was used.

Furthermore, as shown in Tables 3 to 7, the inks (I-1) to (I-5) were excellent in adhesion to the specific recording medium such as the PET sheet. Typically, in a case in which an ink with high adhesion to the specific recording medium is used, cleaning failure tends to occur even when the ejection surfaces of the recording heads are cleaned with a cleaning liquid. However, the cleaning liquids (CA-1) to (CA-17) were evaluated as good in evaluation of accuracy of ink placement and evaluation of cleaning ability of the ejection surfaces of the recording heads even when any of the inks (I-1) to (I-5) with high adhesion to the specific recording medium was used.

From the above, it was demonstrated that the cleaning liquids (CA-1) to (CA-17) encompassed in the present disclosure favorably cleaned even the inks excellent in adhesion to the specific recording medium. It was also demonstrated that the liquid sets (LA-1) to (LA-17) encompassed in the present disclosure each included inks excellent in adhesion to the specific recording medium and a cleaning liquid capable of cleaning such inks.

What is claimed is:

1. A cleaning liquid comprising:
water;
a surfactant; and
glycol ether, wherein
the surfactant includes both a silicone surfactant and a betaine surfactant,
the glycol ether has a percentage content of at least 5.0% by mass and no greater than 15.0% by mass relative to a mass of the cleaning liquid, and
the cleaning liquid has a viscosity at 25° C. of no greater than 10.0 mPa·s.

2. The cleaning liquid according to claim 1, wherein
the cleaning liquid has a contact angle relative to an austenitic stainless steel plate of no greater than 25 degrees.

3. The cleaning liquid according to claim 1, wherein
the silicone surfactant has a percentage content of at least 0.5% by mass and no greater than 1.5% by mass relative to the mass of the cleaning liquid.

4. The cleaning liquid according to claim 1, wherein
the silicone surfactant includes polyether-modified silicone.

5. The cleaning liquid according to claim 1, wherein
the betaine surfactant has a percentage content of at least 0.1% by mass and no greater than 0.5% by mass relative to the mass of the cleaning liquid.

6. The cleaning liquid according to claim 1, wherein
the betaine surfactant is an amphoteric surfactant.

7. The cleaning liquid according to claim 1, wherein
the betaine surfactant includes coconut oil fatty acid amide propyl betaine or lauryl dimethylamino acetate betaine.

8. A inkjet recording apparatus liquid set comprising:
a first liquid; and
a second liquid, wherein
the first liquid is an ink and the second liquid is a cleaning liquid,
the ink contains a pigment particles and water,
the cleaning liquid contains water, a surfactant, and glycol ether,
the surfactant includes both a silicone surfactant and a betaine surfactant,
the glycol ether has a percentage content of at least 5.0% by mass and no greater than 15.0% by mass relative to a mass of the cleaning liquid, and
the cleaning liquid has a viscosity at 25° C. of no greater than 10.0 mPa·s.

9. The inkjet recording apparatus liquid set according to claim 8, wherein
the ink further contains a first resin and a second resin, the first resin being attached to surfaces of the pigment particles, the second resin being in a state of emulsified particles, and
the second resin has a percentage content of at least 0.9% by mass and no greater than 3.0% by mass relative to a mass of the ink.

10. The inkjet recording apparatus liquid set according to claim 9, wherein
the first resin is styrene-acrylic resin, and
the second resin is acrylic resin, polyurethane, or polyolefin.
